(19) United States
(12) Patent Application Publication
(10) Pub. No.: US 2014/0312096 A1
(43) Pub. Date: Oct. 23, 2014

(54) OXY-FUEL WELD REPAIR OF METALLIC COMPONENTS

(71) Applicant: CATERPILLAR INC., Peoria, IL (US)

(72) Inventors: CHRISTOPHER ANTHONY KINNEY, Iuka, MS (US); BENJAMIN JAMES RASMUSSEN, Corinth, MS (US); KEGAN LUICK, Corinth, MS (US)

(73) Assignee: Caterpillar Inc., Peoria, IL (US)

(21) Appl. No.: 13/865,531

(22) Filed: Apr. 18, 2013

(51) Int. Cl. B23P 6/00; B23P 6/02

(52) U.S. Cl. CPC B23P 6/00; B23P 6/02
USPC 228/103; 228/119

(57) ABSTRACT

A method of repairing a metallic component is disclosed. The method may include machining away a damaged first portion of the component, and machining away a second portion of the component adjacent the damaged first portion, the second portion being an area that would be subject to distortion resulting from solidification of molten weld material added to repair the damaged first portion. The method may also include inserting a dam made of a high-temperature-resistant material adjacent the machined away second portion to contain molten weld material added to the machined away second portion. Oxy-fuel welding may be performed to at least partially fill the machined away damaged first portion of the component and the machined away second portion of the component, and final machining of the welded portions may be performed.

### TECHNICAL FIELD

The present disclosure relates generally to oxy-fuel weld repair, and more particularly, to oxy-fuel weld repair of metallic components.

### BACKGROUND

An internal combustion engine generally includes one or more combustion chambers that house a combustion process to produce mechanical work and a flow of exhaust. Each combustion chamber is formed from a cylinder, the top surface of a piston, and the bottom surface of a cylinder head. The cylinder head is typically fabricated from an iron casting or an aluminum casting having cast-in-place cast iron inserts. Air or an air/fuel mixture is directed into the combustion chamber by way of intake ports disposed in the cylinder head, and the resulting exhaust flow is discharged from the combustion chamber by way of exhaust ports also disposed in the cylinder head. Valves are located within the ports of the cylinder head and seal against valve seats to selectively allow and block the flows of air and exhaust.

During engine operation, the cast iron cylinder head or cylinder head inserts are exposed to high pressures and temperatures and, over time, these high pressures and temperatures can cause deterioration of the cylinder head's bottom surface, valve seat pockets, exhaust ports, and other components of the cylinder head. As engine manufacturers are continually urged to increase fuel economy, meet lower emission regulations, and provide greater power densities, cylinder pressures and combustion gas temperatures within the combustion chamber have been increasing. The increased temperatures and pressures experienced by the lower surface of the cylinder head, often referred to as the combustion deck or fireside surface of the cylinder head, may result in damage such as cracks along the bridge portion of the cylinder head between valve seat pockets and between valve seat pockets and the fuel injector bore.

One method for repairing castings such as cylinder heads is disclosed in U.S. Pat. No. 7,047,612 (the '612 patent) issued to Bridges et al. on May 23, 2006. The '612 patent describes a method of repairing a casting by pouring melted filler material into a damaged portion of the original casting. A damaged cast component such as a cylinder head is preheated to a first preheat temperature. The damaged area of the casting is then heated to a higher temperature using a torch, and melted filler material is poured into the casting. Plugs of heat resistant material are used to prevent molten filler material from entering original features of the cylinder head such as exhaust and intake valve openings, and fuel injector bores. Dams are also positioned on the surface being repaired to form a riser of the filler material.

Although the method of the '612 patent may provide an expedited procedure for repairing a casting that does not require manual welding, the damaged component must still be carefully preheated as much as possible without damaging the component in order to avoid cracking the parent material when the molten filler material is poured onto the component. Additional heating with a torch when the molten filler material is introduced may also be required in order to ensure that the area being repaired is hot enough to permit bonding of the parent and filler materials, but cool enough to prevent the filler material from melting through the parent material. The method of the '612 patent may therefore increase the difficulty of maintaining proper temperature control to avoid the formation of bubbles or other defects during the repair process.

The disclosed method for weld repairing metallic components is directed to overcoming one or more of the problems set forth above.

### SUMMARY OF THE DISCLOSURE

In one aspect, the present disclosure is directed to a method of repairing a metallic component. The method may include machining away a damaged first portion of the component, and machining away a second portion of the component adjacent the damaged first portion, the second portion being an area that would be subject to distortion resulting from solidification of molten weld material added to repair the damaged first portion. The method may also include inserting a dam made of a high-temperature-resistant material adjacent the machined away second portion to contain molten weld material added to the machined away second portion. The method may further include oxy-fuel welding weld material that is substantially the same as the material of the damaged first portion to at least partially fill the machined away damaged first portion of the component and the machined away second portion of the component. Final machining may be performed on the welded first portion and the welded second portion of the component.

In another aspect, the present disclosure is directed to a method of repairing a cast iron cylinder head having at least one valve seat pocket machined into a combustion deck surface of the cylinder head, and at least one fuel injector bore machined through the cylinder head and opening on the combustion deck surface. The method may include inspecting the cylinder head along the combustion deck surface to identify defects in the cylinder head, machining away sufficient material from an area of the identified defects to eliminate the defects, reinspecting the cylinder head to verify that all of the identified defects have been removed, and machining away a portion of the fuel injector bore adjacent the machined away area that included defects. The method may also include turning the cylinder head over with the combustion deck surface facing down, machining a spot face in the fuel injector bore to create a land adjacent the machined away portion of the fuel injector bore, inserting a plug made of a high-temperature-resistant material into the fuel injector bore to seal against the land, and turning the cylinder head back over with the combustion deck surface facing up. The method may further include oxy-fuel welding weld material that is substantially the same as the material of the cylinder head to at least fill in the machined away area that had defects and the machined away portion of the fuel injector bore, and final machining areas that have been welded.

### BRIEF DESCRIPTION OF THE DRAWINGS

FIG. 1 is an illustration of an exemplary component to be repaired in accordance with the disclosed methods;

FIG. 2 is a sectional elevation view of the component of FIG. 1 at various stages during the repair process taken along line 2-2 in FIG. 1;

FIG. 3 is a flow chart describing an exemplary disclosed method for repairing the component of FIG. 1.

### DETAILED DESCRIPTION

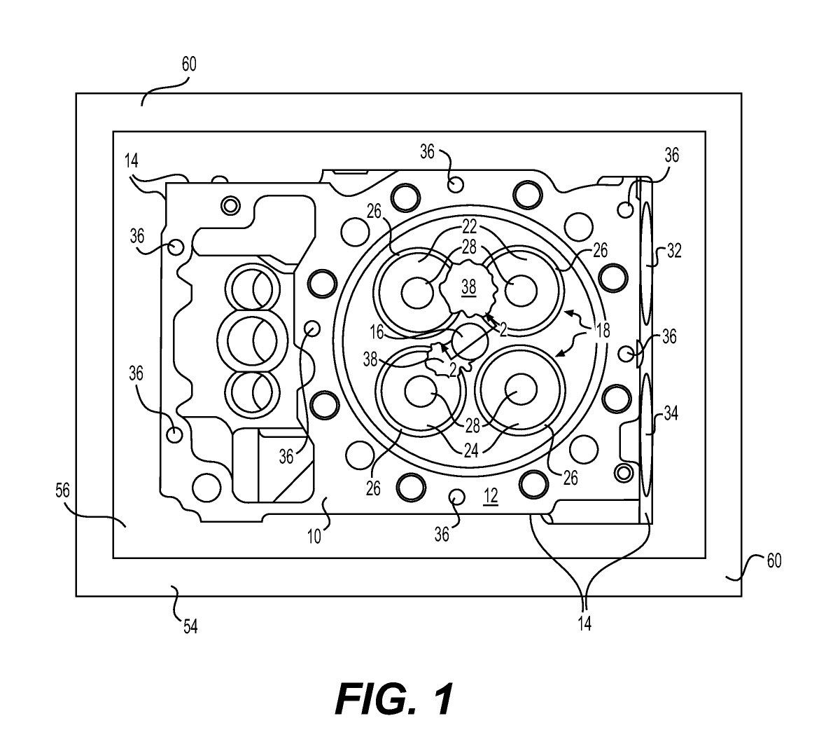

Referring to FIG. 1, an exemplary component manufactured from a material such as grey cast iron is illustrated. In this example the component is a cylinder head 10. The disclosed repair methods may be used with other products that may include configurations with one or more passageways, openings, or bores, and surrounding areas that may include defects such as cracks or fissures. The disclosed implementations may also be used for repairing other metallic components, and in particular, other cast metallic components such as components made from cast iron, cast aluminum, and other materials. Various details of the repair procedures, such as preheat temperatures, intermediate temperatures to which the component or portions of the component are cooled after weld repairing, the way in which portions of a passageway may be sealed off from molten metal during weld repair, and the exact cooling procedures after repair may be determined through experimentation or computer simulation.

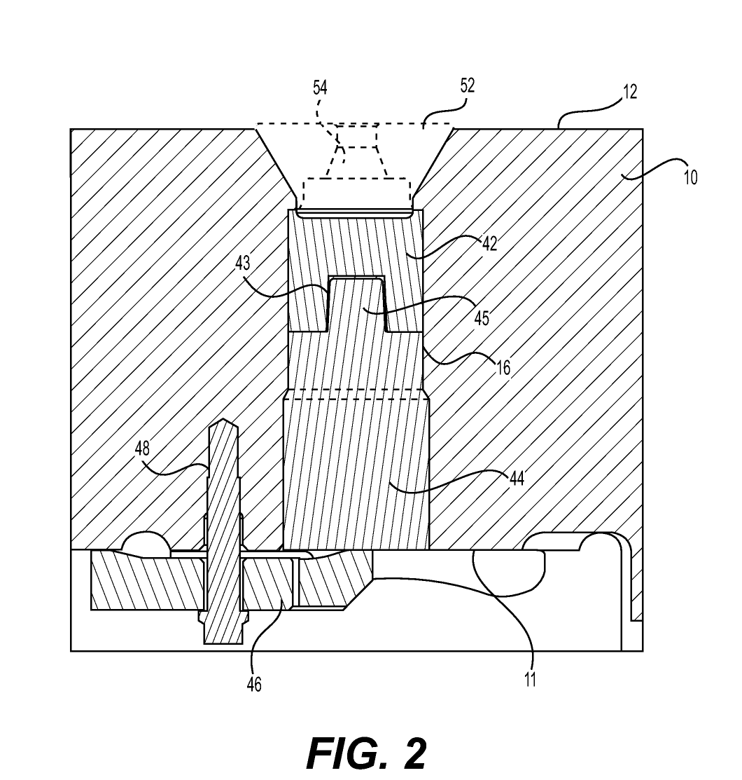

The illustrated exemplary cylinder head 10 may include a bottom, or combustion deck surface 12. Combustion deck surface 12 is the surface of cylinder head 10 that faces the combustion chambers of an engine, and is exposed to the high temperature and pressure gases produced during combustion when the engine is operational. Cylinder head 10 may also include a plurality of side surfaces 14 and a top surface 11 (shown in FIG. 2, with cylinder head 10 positioned upside down from its normal assembled orientation). Combustion deck surface 12 of cylinder head 10 may be adapted to be fastened to a cylinder block (not shown) of an internal combustion engine, in a typical manner. Combustion deck surface 12 of cylinder head 10 may also include a fuel injector bore 16 and valve openings 18. As illustrated, valve openings 18 may include a pair of exhaust valve openings 22 and a pair of intake valve openings 24. Valve openings 18 may be evenly spaced about fuel injector bore 16. Fuel injector bore 16 may extend as a passageway through cylinder head 10, with the passageway including different portions having different diameters and configurations. Each valve opening 18 may include a valve seat pocket 26 and a valve guide bore 28. A passage (not shown) may be defined in cylinder head 10 extending from each valve opening 18 to a respective one of an exhaust port 32 and an intake port 34. The intake and exhaust ports 32, 34 may be defined in one of side surfaces 14 of cylinder head 10. Cylinder head 10 may also include a plurality of bores 36 adapted to receive bolts (not shown) for attaching cylinder head 10 to the engine block. Internally, cylinder head 10 may include a plurality of fluid passages (not shown). The fluid passages may include a coolant jacket and lubrication passages. The coolant jacket and lubrication passages function in a conventional fashion.

Configured for operation with an internal combustion engine (not shown), cylinder head 10 may be assembled having a pair of exhaust valves (not shown) and a pair of intake valves (not shown) movably positioned in valve openings 18. A rocker arm assembly (not shown) may be additionally assembled on cylinder head 10. To facilitate inspection and repair of cylinder head 10, the intake valves, exhaust valves, valve seat inserts, valve guides, rocker arm assembly and all other removable components may be disassembled from cylinder head 10. Inspection for defects or damage such as cracks or fissures in cylinder head 10, and particularly along combustion deck surface 12, may be performed using techniques such as magnetic particle inspection. In this inspection procedure, the entire cylinder head 10 may be magnetized to create essentially a large bar magnet. Whenever cracks form in cylinder head 10, the original bar magnet with north and south poles at each end of the cylinder head becomes essentially a plurality of smaller bar magnets with new north and south poles formed at each of the cracks. As a result, these new magnetic poles at each crack affect the pattern of ferromagnetic powder that may be applied along the combustion deck surface over the cracks, which may otherwise be invisible to the human eye. The ferromagnetic powder may consist essentially of iron particles, and the iron particles may be coated with a dye that fluoresces when exposed to black light, thereby further enhancing the visibility of the cracks during inspection with a black light.

Referring to FIGS. 1 and 2, the area between valve openings 18 forms a bridge between the valve openings. These bridge areas of combustion deck surface 12, and the area surrounding each fuel injector bore 16 may form areas that develop defects such as cracks or fissures as a result of continued exposure to the high temperature and pressure gases produced during combustion. These pressures and temperatures may be as great as 3200 pounds per square inch (psi) and 800 degrees Fahrenheit (° F.), or even greater when certain conditions are experienced, such as failure of the cooling system to circulate coolant through the cooling passages in cylinder head 10. In these situations, or as a result of exposure to typical combustion conditions over time, a crack (not shown) may propagate in the bridge between valve openings, or between valve openings and the fuel injector bore.

After identifying cracks using inspection techniques such as magnetic particle inspection, the extent of the identified cracks may be marked with various marking devices such as a mechanical scribing marker that will allow a machinist to identify the location of the cracks. A component such as cylinder head 10 with cracks in areas along a surface such as combustion deck surface 12, may be supported by a jig or machining fixture to allow for machining away of the damaged portions. Various automated and manual machining operations such as milling, boring, grinding, and drilling may be performed to remove the damaged portions, leaving voids 38 where the material with defects has been removed. Fuel injector bore 16 may extend through cylinder head 10 from top surface 11 to combustion deck surface 12, as shown in FIG. 2. Defects such as cracks may also form around fuel injector bore 16 where it meets combustion deck surface 12. In various embodiments of cylinder head 10, fuel injector bore 16 may include precision machined, cone-shaped features 54 at the longitudinal end of fuel injector bore 16 near combustion deck surface 12. Precision machined, cone-shaped features 54 may form the surfaces against which mating surfaces of a fuel injector seal to prevent gases or liquids from entering fuel injector bore 16 around an installed fuel injector. Fuel injector bore 16 may also include an intermediate portion of larger diameter extending further into cylinder head 10 from the precision machined, cone-shaped features at the one longitudinal end near combustion deck surface 12. This intermediate portion may then be enlarged to an even larger diameter portion of fuel injector bore 16 extending to the top surface 11 of cylinder head 10, as shown in FIG. 2. One of ordinary skill in the art will recognize that the exact configuration of fuel injector bore 16 in cylinder head 10 may vary depending on the type and model of cylinder head. In some alternative implementations, fuel injector bore 16 may be a substantially constant diameter cylindrical bore with internal threads that are configured to engage with an externally threaded fuel injector burner tube. A clamping member 46 may be provided and bolted to top surface 11 using one or more bolts 48 to provide a means for holding a fuel injector in fuel injector bore 16 during a typical assembled configuration of cylinder head 10.

As shown in FIG. 1, voids 38 left after machining away damaged portions of cylinder head 10 along combustion deck surface 12 may extend in the bridge area between valve seat pockets 26, or between a valve seat pocket 26 and fuel injector bore 16. As shown in FIG. 2, a conical shaped portion 52 located at the end of fuel injector bore 16 intersecting combustion deck surface 12 may also be machined away from cylinder head 10. The conical shaped portion 52 may be machined to taper out to combustion deck surface 12 in order to remove material that may be subject to distortion resulting from solidification of molten weld material added to voids 38 during a weld repair process. The dashed portion of conical shaped portion 52 extending above combustion deck surface 12 in FIG. 2 illustrates a potential future build-up of weld material that may fill conical shaped portion 52 during the weld repair process. When molten weld material filling voids 38 solidifies, it shrinks, pulling material from around the repaired area toward the repaired area. The weld repaired areas along the bridges between valve seat pockets 26 and between valve seat pockets 26 and fuel injector bore 16 may be located in close proximity to fuel injector bores 16. As a result, the shrinkage during solidification of the molten weld material added to voids 38 may cause egg-shaped distortions in the end of fuel injector bores 16 near combustion deck surface 12. The precision machined, cone-shaped features 54 (shown as dashed lines in FIG. 2 since these features will be machined away to create conical shaped portion 52) at the end of each fuel injector bore 16 may become distorted, and there may not be sufficient material to remachine these precision features. The weld repair procedures in accordance with various implementations of this disclosure may therefore include building up weld material in the machined away conical shaped portion 52. This added weld material may be built up above combustion deck surface 12 as illustrated in FIG. 2 for reasons that will become apparent in the following discussion. This added weld material in conical shaped portion 52 may then be machined to recreate the precision machined, cone-shaped features 54 at the end of a fuel injector bore 16 that gets distorted by shrinkage during solidification of molten weld material added to voids 38. The machining away of the conical shaped portion 52, and weld build-up of this machined away portion of fuel injector bore 16 may be performed in anticipation of potential distortion resulting from solidification of molten weld material in voids 38, in spite of not actually finding any cracks or other damage in the machined away portion of fuel injector bore 16.

As shown in FIG. 2, a plug 42 (also referred to as a dam) made of a high-temperature-resistant material such as ceramic or graphite may be positioned within fuel injector bore 16 adjacent the machined away conical shaped portion 52 to contain molten weld material added to the machined away portion during the weld repair process. One of ordinary skill in the art will recognize that FIG. 2 illustrates one possible implementation of the disclosed weld repair process at a point in the process when precision machined cone-shaped features 54 have been machined away to leave conical shaped portion 52. The dashed portion of 52 shown protruding above combustion deck surface 12 illustrates one possible implementation at the point when weld material has been built up above combustion deck surface 12 to create a weld cap of excess weld material. After machining away conical shaped portion 52 to remove precision machined cone-shaped features 54, and before the weld build-up of the machined away areas, cylinder head 10 may be flipped over with combustion deck surface 12 facing down, and a spot face may be machined within fuel injector bore 16 adjacent the conical shaped portion 52 to provide a land against which plug 42 may seal. A spacer 44 may be configured to fit within fuel injector bore 16 and hold plug 42 against the land adjacent conical shaped portion 52. Spacer 44 may include a mating portion 45 configured to engage with a blind hole 43 formed in one side of plug 42. Mating portion 45 of spacer 44 may be threaded for threaded engagement with internal threads in blind hole 43 in certain implementations. The opposite side of plug 42 may be configured with a concave face that will contain the molten weld material added to the machined away, conical shaped portion 52 of cylinder head 10. In alternative implementations and variations, one of ordinary skill in the art will recognize that plug 42 may have other configurations, and the surface or surfaces of plug 42 that contain the molten weld material may be flat, convex, or of other configurations. Plug 42 may also be produced using different processes including, but not limited to casting and machining. Spacer 44 may be configured with the correct dimensions to press plug 42 against the land adjacent conical shaped portion 52. A clamping member 46 may be tightened against the end of spacer 44 opposite from the end having mating portion 45 using bolts 48 threaded into top surface 11 of cylinder head 10. Clamping member 46 may be a standard clamp used to hold a fuel injector in fuel injector bore 16 during a typical assembled configuration.

Additional equipment (not shown) used during weld repair procedures in accordance with various implementations of this disclosure may include a machining jig or fixture configured for holding cylinder head 10 in the proper orientation during various machining processes. The machining processes, such as milling, grinding, boring, and drilling, may be employed to machine away damaged portions of cylinder head 10 along combustion deck surface 12 in the bridge area between valve seat pockets 26, between valve seat pockets 26 and injector bores 16, and in the lower portions of fuel injector bores 16 intersecting with combustion deck surface 12. The machining away of damaged portions may allow for removal of the damaged material in a conical shaped configuration that opens up toward combustion deck surface 12 to allow a welder to gradually build up molten weld material in the machined away area. Fixtures and other devices may also be employed to flip over cylinder head 10 after portions of combustion deck surface 12 have been machined away, to enable the spot facing of a sealing surface down in fuel injector bore 16 adjacent the machined away conical shaped portion 52.

After all of the machining away of damaged portions along the bridges between valve seat pockets, between valve seat pockets and the injector bores, and in other portions of injector bores 16 is completed, another fixture may be used during the weld repair process. This fixture may be made from a high temperature nickel based superalloy, or other high temperature stable materials, and may be used to mount cylinder head 10 to control deformation of cylinder head 10 caused by changes in temperature during oxy-fuel welding and during cooling after weld repair. The fixture may also be configured to maintain cylinder head 10 in a desired orientation during the weld repair process.

A furnace may also be used to preheat cylinder head 10 after machining away the damaged portions and portions of fuel injector bores 16, and after insertion of plug 42 using spacer 44 and clamping member 46, but before oxy-fuel welding of the machined away portions. A furnace may be an electric furnace, a gas furnace, an infrared furnace, or any of other known types of furnaces capable of preheating cylinder head 10 to temperatures in a range from approximately 1100 degrees Fahrenheit to 1200 degrees Fahrenheit. In alternative implementations, the preheating may also be performed in a more localized fashion using a torch or other manually controlled heating device. After preheating, each cylinder head ready for weld repair may be placed in a smaller, portable weld box that is a furnace with removable, insulated lid sections covering different sections of cylinder head 10. The portable weld box may be configured to be rolled into a room where a welder can access various sections of cylinder head 10 through openings in a wall separating the weld box from an air conditioned compartment where the welder is located. The weld box may be configured to maintain the preheated temperature of cylinder head 10 as each section of cylinder head 10 is accessed behind a removable lid section.

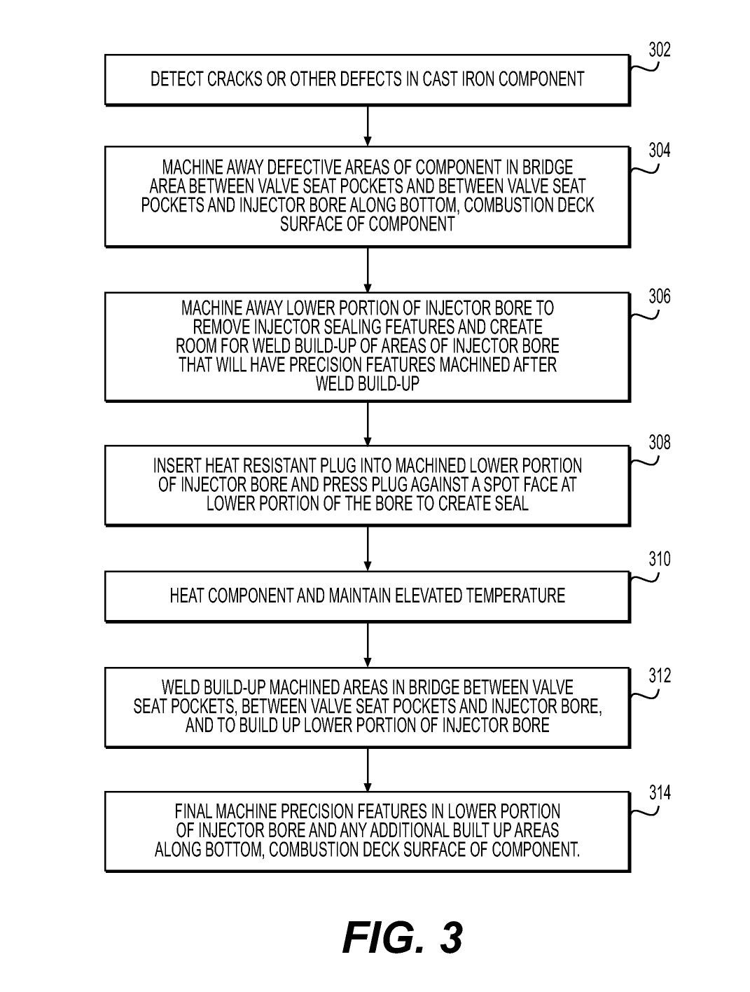

FIG. 3 illustrates an exemplary disclosed method of weld repairing a cast iron component, such as a cylinder head. FIG. 3 will be discussed in more detail in the following section to further illustrate the disclosed concepts.

### INDUSTRIAL APPLICABILITY

The disclosed methods of weld repair may be applicable to a wide variety of metallic components such as cast iron engine components or other metallic components where the weld repair may allow for continued use of damaged parts. The disclosed methods allow for careful control of the temperatures a component reaches during the repair process, as well as reducing difficulties often associated with trying to tie together different heating times and temperatures of components that are being bonded together in the welding process. The disclosed methods only require coordinating the heating times and temperatures of the base metal in the component with the weld material being added from a weld rod. The precise control of the heating times and temperatures also avoids the formation of any pockets or bubbles in the weld material that is added to build up damaged areas that have been machined away. Weld build-up of areas that have been machined away because they are potentially subject to distortion during the weld repair process also enables final machining after weld repair to the precise dimensions required in many components.

As shown in FIG. 3, one exemplary implementation may include step 302 to detect cracks or other defects in a cast iron component, such as a cylinder head for an engine. This step may be performed by using any of a number of different inspection methods, including magnetic particle inspection, as discussed above.

After detecting damage such as cracks or other defects, the disclosed exemplary implementation may include step 304 to machine away the defective areas of the component. In the case of a cylinder head for an engine, the procedure may include step 304 to machine away defective areas of the cylinder head in the bridge area between valve seat pockets and between valve seat pockets and an injector bore along the bottom, combustion deck surface of the cylinder head. In various alternative implementations the step 302 to detect cracks or other defects may be repeated after machining away sufficient material from an area of the identified defects to eliminate the defects. Detection of defects and machining away of detected defects may be repeated to achieve a desired level of confidence that all defects have been removed. The exemplary process may also include step 306 to machine away a lower portion of injector bore 16 to remove injector sealing features and create room for weld build-up of areas of the injector bore that will have precision features remachined after the weld build-up. As shown in FIG. 2, this machined away lower portion of fuel injector bore 16 may form conical shaped portion 52 that tapers out toward combustion deck surface 12 of cylinder head 10. As explained above, the machining away of a portion of the injector bore may be performed even though no defects have been detected in that area in order to create room for weld build-up that may be needed to compensate for solidification-induced shrinkage and distortions to precision machined areas of the injector bore.

The exemplary repair process may further include step 308 to insert a heat resistant plug or dam 42 into the machined lower portion of injector bore 16, and press the plug against a spot face at the lower portion of the bore to create a seal. As shown in FIG. 2, heat resistant plug 42 may be inserted into fuel injector bore 16 from the top surface 11 of cylinder head 10, and held in position by spacer 44 and clamping member 46 against the land created by spot facing injector bore 16 adjacent to the machined away conical shaped portion 52.

After machining away damaged portions of combustion deck surface 12 of cylinder head 10, and portions of fuel injector bore 16, the exemplary repair process may include step 310 to heat the component and maintain the elevated temperatures. As discussed above, the heating may be achieved in a furnace, or by using a torch or other manual methods. Once preheated, cylinder head 10 may be maintained at the preheated temperatures by keeping cylinder head 10 in a portable weld box/furnace that is then moved into the weld repair area and allows for access to isolated portions of cylinder head 10 during welding.

After preheating cylinder head 10, the exemplary process may include step 312 to weld build-up machined areas in the bridge between valve seat pockets, between valve seat pockets and the injector bore, and to build up the lower portion of injector bore 16. The machined areas may be shaped to taper outward toward combustion deck surface 12, such as illustrated by conical shaped portion 52 at the lower portion of fuel injector bore 16. This configuration of the machined away areas allows a welder to build up weld material in the machined away areas, with areas of the weld material that are solidifying providing support for additional weld material that continues to be added to the voids. When building up weld material in the machined away conical shaped portion 52 at the lower end of fuel injector bore 16, a welder may build up the weld material from the dam or plug 42 to create a cap or raised volume of weld material above combustion deck surface 12. In one exemplary technique for performing this weld build-up, the welder may move the weld rod in a circular pattern as weld material is added to the machined away portion above plug 42 to create a doughnut-shaped volume of molten weld material that is worked out against an outer circumferential region where plug 42 meets cylinder head 10. Because the dam or plug 42 may be formed from a high-temperature-resistant material such as ceramic or graphite, the welder may also dip the weld rod in a flux in order to help improve the wettability of the concave face of plug 42 as molten weld material is built up in conical shaped portion 52. The flux may be used in order to help the molten weld material bond to cylinder 10 in the circumferential region where the dam meets cylinder head 10.

As machined areas are built up with weld material at step 312, this weld build-up may continue above combustion deck surface 12. A welder may build up weld material in the machined away lower portion of fuel injector bore 16 sufficiently far above the dam or plug 42 to move an approximate center of mass of the solidifying weld material higher relative to the dam. As the molten weld material solidifies the last portion to solidify is generally at the center of mass of added weld material. As the molten weld material solidifies it also shrinks, tending to pull surrounding material inward toward the center. However, as the very last portions near the center of mass of the molten weld material are solidifying, the surrounding areas of weld material have already solidified, and therefore can no longer be pulled inward toward the center of mass. This may result in the formation of bubbles or voids, commonly referred to as shrink, at the very center of the solidifying mass of molten weld material. When final machining is done after the weld build-up, these bubbles or voids may result in undesirable porosity in areas of the final machined surface that intersect with the bubbles. Therefore the process of building up the weld material above combustion deck surface 12, as illustrated by the dashed line of conical shaped portion 52 in FIG. 2, may move the center of mass of the solidifying molten weld material high enough relative to combustion deck surface 12 so that any bubbles or voids formed at the center of mass will be located away from an area where precision machined cone-shape features 54 will be final machined into fuel injector bore 16.

After the weld build-up at step 312 is completed for all machined away portions of cylinder head 10, everything may be allowed to gradually cool back down to ambient temperature before moving cylinder head 10 to another machining fixture or jig for final machining. The process may include step 314 to final machine precision features in the lower portion of injector bore 16, such as precision machined, cone-shaped features 54, and any additional built up areas along the bottom, combustion deck surface 12 of cylinder head 10.

It will be apparent to those skilled in the art that various modifications and variations can be made to the disclosed method of weld repairing metallic components. Other embodiments will be apparent to those skilled in the art from consideration of the specification and practice of the disclosed weld repair methods. It is intended that the specification and examples be considered as exemplary only, with a true scope being indicated by the following claims and their equivalents.

What is claimed is:

1. A method of repairing a metallic component, comprising:
machining away a damaged first portion of the component;
machining away a second portion of the component adjacent the damaged first portion, the second portion being an area that would be subject to distortion resulting from solidification of molten weld material added to repair the damaged first portion;
inserting a dam made of a high-temperature-resistant material adjacent the machined away second portion to contain molten weld material added to the machined away second portion;
oxy-fuel welding weld material that is substantially the same as the material of the damaged first portion to at least partially fill the machined away damaged first portion of the component and the machined away second portion of the component; and
final machining the welded first portion and the welded second portion of the component.

2. The method of claim 1, wherein:
machining away the second portion of the component includes machining away precision machined features of the second portion of the component to make room for the addition of sufficient weld material to enable remachining of the precision machined features after any distortion resulting from solidification of molten weld material added to repair the damaged first portion.

3. The method of claim 1, further including preheating the metallic component after machining away the damaged first portion and machining away the second portion, but before the oxy-fuel welding.

4. The method of claim 1, further including:
mounting the component on a fixture before the oxy-fuel welding, the fixture configured to control deformation of the component caused by changes in temperature of the component during the oxy-fuel welding and during cooling of the component after weld repair, and the fixture configured to maintain the component in a desired orientation for the oxy-fuel welding.

5. The method of claim 1, further including:
performing magnetic particle inspection of the component to identify defects in the component;
marking the identified defects with a marking device;
machining away sufficient material from the area of the marked defects to eliminate the defects; and
reinspecting the component to verify that all of the identified defects have been removed.

6. The method of claim 1, wherein the metallic component is a cylinder head for an engine, the damaged first portion of the component is located in one of a bridge area of a combustion deck surface of the cylinder head between two valve seat pockets or an area of the combustion deck surface of the cylinder head between a valve seat pocket and a fuel injector bore, and the second portion of the component is located within the fuel injector bore near the combustion deck surface, the method further including:
turning the metallic component over with the combustion deck surface faced down; and
machining a spot face in the fuel injector bore adjacent the machined away second portion of the component to create a land against which the dam can be engaged to form a seal against the molten weld material added to the machined away second portion of the component.

7. The method of claim 6, further including:
mounting the dam on a spacer to form an assembly configured to fit within the fuel injector bore; and
pressing the dam against the land by clamping the assembly into the fuel injector bore.

8. The method of claim 7, wherein the dam includes a concave face on one side for containing the molten weld material added to the machined away second portion of the component, and a blind hole on a side opposite from the side of the dam with a concave face, and wherein:
mounting the dam on the spacer includes engaging a mating portion at a first end of the spacer with the blind hole in the dam, and
pressing the dam against the land includes inserting the assembly of the dam and the spacer into the fuel injector bore from a side of the cylinder head opposite from the combustion deck surface, and tightening a clamp against a second end of the spacer opposite from the first end, the clamp being configured to engage with the side of the cylinder head opposite from the combustion deck surface for holding a fuel injector in the fuel injector bore.

9. The method of claim 6, wherein:
the oxy-fuel welding builds up weld material in the machined away damaged first portion of the component and in the machined away second portion of the component to form a cap of weld material extending above the combustion deck surface of the cylinder head.

10. The method of claim 9, wherein the oxy-fuel welding in the machined away second portion of the component includes at least initially moving a weld rod in a circular pattern as weld material is added to the machined away second portion to create a doughnut-shaped volume of molten weld material that is worked out against an outer circumferential region where the dam meets the cylinder head.

11. The method of claim 2, wherein the oxy-fuel welding builds up weld material in the machined away second portion of the component sufficiently far from the dam to move an approximate center of solidifying weld material added to the machined away second portion of the component far enough relative to the dam to be located away from the remachined precision machined features.

12. The method of claim 1, wherein the dam is made from a ceramic material.

13. The method of claim 1, wherein the dam is made from a graphite material.

14. The method of claim 3, wherein the preheating is performed by placing the component in a furnace and heating the component to approximately 1100 degrees Fahrenheit −1200 degrees Fahrenheit.

15. The method of claim 1, wherein component is cooled after the welding and before the final machining.

16. A method of repairing a cast iron cylinder head having at least one valve seat pocket machined into a combustion deck surface of the cylinder head, and at least one fuel injector bore machined through the cylinder head and opening on the combustion deck surface, the method comprising:
inspecting the cylinder head along the combustion deck surface to identify defects in the cylinder head;
machining away sufficient material from an area of the identified defects to eliminate the defects;
reinspecting the cylinder head to verify that all of the identified defects have been removed;
machining away a portion of the fuel injector bore adjacent the machined away area that included defects;
turning the cylinder head over with the combustion deck surface facing down;
machining a spot face in the fuel injector bore to create a land adjacent the machined away portion of the fuel injector bore;
inserting a plug made of a high-temperature-resistant material into the fuel injector bore to seal against the land;
turning the cylinder head back over with the combustion deck surface facing up;
oxy-fuel welding weld material that is substantially the same as the material of the cylinder head to at least fill in the machined away area that included defects and the machined away portion of the fuel injector bore; and
final machining areas that have been welded.

17. The method of claim 16, further including preheating the cylinder head after machining away the area that included defects and the portion of the fuel injector bore, and after inserting the plug, but before the oxy-fuel welding.

18. The method of claim 16, further including:
mounting the cylinder head in a fixture before the oxy-fuel welding, the fixture configured to control deformation of the cylinder head caused by changes in temperature of the cylinder head during the oxy-fuel welding and during cooling of the component after weld repair, and
the fixture configured to maintain the component in a desired orientation for the oxy-fuel welding.

19. The method of claim 16, wherein:
the oxy-fuel welding builds up weld material over at least the machined away portion of the fuel injector bore to form a cap of weld material extending above the combustion deck surface of the cylinder head.

20. The method of claim 16, wherein inserting the plug includes installing the plug on an end of a spacer configured to fit within the fuel injector bore, inserting the plug and spacer into the fuel injector bore, and pressing the plug against the land by clamping the spacer into the fuel injector bore using a same clamping member as used for holding a fuel injector in the fuel injector bore.
